(19) United States
(12) Patent Application Publication
(10) Pub. No.: US 2022/0335548 A1
(43) Pub. Date: Oct. 20, 2022

(54) FRYING OIL PROCESSING WORK INFORMATION REPORTING SYSTEM AND FRYING OIL PROCESSING WORK INFORMATION REPORTING METHOD

(71) Applicant: J-OIL MILLS, Inc., Tokyo (JP)

(72) Inventors: Takeshi SUZUKI, Tokyo (JP); Masami INOUE, Tokyo (JP); Kazuhiko HAKAMADA, Tokyo (JP); Shinsuke KOZONO, Tokyo (JP); Kenichi WATANABE, Tokyo (JP)

(21) Appl. No.: 17/760,669

(22) PCT Filed: Jul. 30, 2020
(86) PCT No.: PCT/JP2020/029361

§ 371 Date: Mar. 15, 2022

(30) Foreign Application Priority Data
Sep. 27, 2019 (JP) 2019-176824

(51) Int. Cl. G06Q 50/12; A47J 37/12; G06Q 10/06; G06Q 10/10

(52) U.S. Cl. CPC G06Q 50/12; A47J 37/1266; G06Q 10/06314; G06Q 10/06395; G06Q 10/1097

(57) ABSTRACT

Provided is a system for reporting frying oil processing work information, with which frying oil processing work can be appropriately carried out. The frying oil processing work information reporting system comprises a deterioration state analysis unit 55 that analyzes a state of deterioration of frying oil 17 in a fryer 14, a processing work information recognition unit 56 that recognizes information about processing work for the frying oil 17 on the basis of the result of the analysis performed on the state of deterioration of the frying oil 17, and a first reporting unit 57 that is set up in a shop 32 and that reports the processing work information.

### TECHNICAL FIELD

The present invention relates to a frying oil processing work information reporting system and a frying oil processing work information reporting method that assist processing work on frying oil used to cook fried foods.

In the prior art, some convenience shops, etc., have adopted a business model in which fried foods cooked in a fryer installed in a shop or a factory are provided to customers. At such convenience shops, etc., shop employees manage frying oil for the fryer.

The frying oil in the fryer deteriorates as, for example, the quantity of fried foods that are cooked (the number of fried items) increases. Therefore, in order to maintain the quality of the fried foods cooked with the frying oil, it is necessary to replace the frying oil with new frying oil when the frying oil has reached a threshold degree of deterioration or before the threshold value is reached.

Usually, waste oil is recovered and frying oil is supplied by an external contractor who contracts to multiple shops. In addition, cleaning of the fryer may be outsourced to an external specialized cleaning company as appropriate in order to reduce the burden on employees.

For example, the system described in Patent Document 1 is known as a system for smoothly carrying out frying oil processing work such as replacement work, waste oil recovery work, supply work, and cleaning work.

Patent Document 1 discloses a shop assistance system that, when various shop tasks (work) performed by multiple shopworkers in a predetermined cycle are to be performed in tandem, generates schedule information in which work is assigned to available shopworkers and reports the schedule information to the shopworkers. According to this shop assistance system, schedule information is generated based on degrees of priorities, workloads, target periods, etc., of the tasks.

### PRIOR ART DOCUMENTS

### Patent Documents

[Patent Document 1] Japanese Laid-Open Patent Application No. 2019-101758

### DISCLOSURE OF THE INVENTION

### Problems the Invention is Intended to Solve

However, the progress of deterioration of frying oil in a fryer in a shop differs depending on, for example, the type of fried food fried in the frying oil. In addition, because the number of fried foods sold in the same shop or between shops varies greatly depending on the date, time, and circumstances, the progress of deterioration of the frying oil also varies greatly depending on the date, time, and circumstances. As a result, the nature of the work of managing frying oil is not uniform.

However, the schedule information generated in the system described in Patent Document 1 indicates that a fixed task in one shop is divided into multiple tasks and the tasks are allocated to available shopworkers.

Therefore, when a task includes the work of processing an object of which properties change depending on the circumstances, such as the degree of deterioration of frying oil, the system described in Patent Document 1 has had a problem in that the processing work related to the object cannot be properly carried out in cases such as when the schedule executor does not have adequate knowledge about the object. Problems are also presented in it not being possible to compare degrees of deterioration of frying oil between shops, and the quality of frying oil cannot be kept constant between shops.

An object of the present invention is to provide a system and method for reporting frying oil processing work information with which the work of processing frying oil can be properly carried out, and a system and method for determining and reporting any abnormality in a fried food cooking location.

### Means for Solving the Aforementioned Problems

A frying oil processing work information reporting system, of the present invention, includes a fryer filled with frying oil for frying fried food and installed in a fried food cooking location, a deterioration state analysis unit that analyzes a state of deterioration of the frying oil in the fryer, a processing work information recognition unit that recognizes information about processing work for the frying oil based on the result of the analysis performed by the deterioration state analysis unit on the state of deterioration of the frying oil, and a first reporting unit that reports the processing work information.

According to the present invention, in a system, a state of deterioration of frying oil in a fryer in a fried food cooking location is analyzed, information about processing work for the frying oil is recognized based on the analysis result, and the recognized processing work information is reported.

As a result, even in cases such as when the person in charge of cooking does not have sufficient knowledge about the frying oil, the work of processing of the frying oil, of which deterioration progresses depending on the circumstances, can be performed properly merely by following the reported processing work information.

Preferably, the frying oil processing work information reporting system of the present invention comprises:

a schedule recognition unit that recognizes at least one schedule of an operation schedule of the fryer, a business hours schedule of the fried food cooking location, and a working hours schedule for a person in charge of cooking in the fried food cooking location; and a schedule planning unit that, based on the schedule recognized by the schedule recognition unit and the result of the analysis performed by the deterioration state analysis unit, plans a processing work schedule to be included in the processing work information reported by the first reporting unit.

Thus, when the processing work schedule is planned based on the schedule of the shop as a whole other than the work of processing the frying oil, which includes at least one schedule from among an operation schedule for the fryer, a business hours schedule for the fried food cooking location, and a working hours schedule for a person in charge of cooking in the fried food cooking location, and also based on the result of the analysis performed by the deterioration state analysis unit, the planned processing work schedule is rationalized accounting for not only the work of processing the frying oil, of which deterioration progresses according to the circumstances, but also the schedule of the fried food cooking location as a whole.

As a result, if the person in charge of cooking performs the processing work in accordance with the processing work schedule, the processing work can be performed at a timing appropriate for not only the work of processing the frying oil but for other work as well, and it is therefore possible to rationalize the procedure of work to be performed and improve labor in the fried food cooking location overall.

Preferably, when a schedule planning unit is included in the frying oil processing work information reporting system of the present invention, the processing work schedule includes a start timing for at least one type of work among waste oil work for the frying oil, cleaning work for the fryer, and work of replenishing the fryer with the frying oil.

Thus, an executor of the schedule can ascertain what processing work should be performed, even if it is only including start timings for work related to the frying oil in the schedule planned by the schedule planning unit, and business can therefore be improved.

Preferably, in the frying oil processing work information reporting system of the present invention,

the schedule planning unit plans the processing work schedule such that at least one set of work periods overlap or do not overlap each other among work periods for the waste oil work, work periods for the cleaning work, and work periods for the replenishment work for a plurality of fryers in the same fried food cooking location.

When there are a plurality of fryers in the same fried food cooking location and thus the timings of processing work for the frying oil therein are intentionally caused to overlap, the processing work can be integrated and the work time can be shortened. When the timings are intentionally caused to not overlap, even when there are few people in charge of cooking, it is possible to prevent the processing of another fryer from stopping while the processing for one fryer is being performed, and to facilitate processing work.

Preferably, when a schedule planning unit is included in the frying oil processing work information reporting system of the present invention,

the schedule planning unit plans the processing work schedule of the fried food location independently of the result of an analysis performed by the deterioration state analysis unit of another fried food location.

According to the configuration, the schedule planning units associated with individual fried food cooking locations can plan a processing work schedule without the analysis results of the other fried food cooking locations. The schedule planning units of the individual fried food cooking locations can thereby plan the processing work schedules of the fried food cooking locations independently, and can therefore quickly plan the processing work schedules of the original locations without having to communicate with the schedule planning units of other fried food cooking locations, thus reducing the processing load.

Preferably, in the frying oil processing work information reporting system of the present invention, the schedule planning unit plans the processing work schedule of the fried food location based on the result of an analysis in the deterioration state analysis unit of another fried food location.

There are cases in which it is better for the processing work schedules for the frying oil in the individual fried food cooking locations to be planned by coordinating among multiple fried food cooking locations than to be planned independently in each fried food cooking location. An example of such a case is that when neighboring fried food cooking locations request waste oil recovery work to be performed by a waste oil recovery contractor who services both locations, the location that made the request in accordance with a waste oil recovery period will be visited by the contractor sooner.

According to this configuration, the schedule planning unit plans the processing work schedule based on both the analysis result of the original fried food cooking location and the analysis result of another fried food cooking location; therefore, the processing work schedule of the original fried food cooking location is coordinated with the processing work schedule of the other fried food cooking location, and it is possible to plan a processing work schedule that contributes to improving, inter alia, the speed and efficiency of the processing work in the original fried food cooking location.

Preferably, when a schedule planning unit is included in the frying oil processing work information reporting system of the present invention,

the schedule planning unit plans the processing work schedule of the fried food cooking location based on a schedule of at least one contractor among a waste oil recovery contractor performing waste oil work, a cleaning work contractor performing cleaning work, and a supply contractor supplying the frying oil to the fried food cooking location.

According to the configuration, it is possible to plan a processing work schedule that matches the processing work schedule planned by the schedule planning unit and the schedule of at least one contractor. As a result, the schedule planning unit can plan a processing work schedule that improves cooperation with external contractors.

Preferably, when the frying oil processing work information reporting system of the present invention refers to the schedules of other contractors to plan a schedule, the schedule planning unit is further provided with a notification unit that issues a notification of the processing work schedule of the fried food cooking location to at least one contractor among a waste oil recovery contractor performing waste oil work, a cleaning work contractor performing cleaning work, and a supply contractor supplying the frying oil to the fried food cooking location.

According to the configuration, at least one contractor can set a schedule corresponding to the processing work schedule of which a notification was issued, and business can therefore be improved not only in the fried food cooking locations, but also in an overall network relating to business and including the fried food cooking locations.

Preferably, the frying oil processing work information reporting system of the present invention further includes

an abnormality determination unit that determines whether or not there is any abnormality in the frying oil in the fryer of the fried food cooking location based on a comparison between the result of the analysis in the deterioration state analysis unit of the fried food cooking location and the result of the analysis in the deterioration state analysis unit of another fried food cooking location regarding the frying oil in the fryer of the other fried food cooking location, and

a second reporting unit that reports the fried food cooking location for which the abnormality determination unit determined there to be abnormality in the frying oil in the fryer.

One method of determining abnormality in the usage of the frying oil by the fried food cooking location is to set a threshold value for the progress of the state of deterioration of the frying oil in the fried food cooking location, and to make a comparison with the threshold value to determine whether or not the frying oil is being used abnormally. For example, an abnormality may occur in which the time to reach the threshold value is shortened due to, inter alia, a failure of a temperature sensor attached to the fryer.

Therefore, in this way, by referring to the past information for the original fried food cooking location and the result of analyzing the frying oil of another store or another factory in order to determine abnormality, abnormality can be appropriately determined if, for example, a fried food cooking location that has similar characteristics (location, customer attributes, etc.) to the original fried food cooking location is employed as the other fried food cooking location.

Preferably, in the frying oil processing work information reporting system of the present invention, the deterioration state analysis unit analyzes the state of deterioration of the frying oil based on at least one of the following: color of the frying oil in the fryer, viscosity, viscosity increase rate, acid value, odor, cumulative time at or above reference temperature, sound generated by the frying oil during deep-frying, oil temperature when the frying oil emits smoke, state of foam generation, amount of polymer on the inner surface of the fryer, accumulated amount of decomposition product due to volatilization of the frying oil, and amount of electric power or gas consumed by the fryer.

According to this configuration, based on various detection parameters, the state of deterioration of the frying oil in the fryer can be accurately analyzed in accordance with the environment of the analysis. When the color of frying oil is used as a detection parameter, subtle color changes can be detected easily and inexpensively from an image captured by a color camera. When the viscosity, the viscosity increase rate, or the acid value is used as a detection parameter, the detection precision can be improved because the variation in the correspondence between these parameters and the state of deterioration of the frying oil is small.

Because odor diffuses readily into the surroundings, when odor is used as a detection parameter, the state of deterioration of the frying oil can be detected even from a location sufficiently distant from the fryer. When the cumulative time at or above the reference temperature of the frying oil is used as a detection parameter, the variation in the detected value is small, and the state of deterioration of the frying oil can therefore be detected inexpensively and precisely with little space using a temperature sensor and a timer. When the sound generated by the frying oil at the time of deep-frying is used as a detection parameter, an inexpensive microphone or the like can be used as a sensor.

When the temperature at the time of smoke emission from the frying oil is used as a detection parameter, the relationship between the temperature at the time of smoke emission and the temperature of the frying oil is highly reliable, and it is therefore possible to detect the state of deterioration of the frying oil with high reliability. Because the state of foam generation in the frying oil can be easily detected from an image captured by a camera, oversight can be reduced. The amount of polymer on the inner surface of the fryer and the accumulated amount of decomposition product due to volatilization of the frying oil can be detected even while the fryer is stopped, and it is therefore possible to reduce restrictions on detection time. When the amount of electric power or gas consumed by the fryer is used as a detection parameter, a power meter or a gas meter can be attached to the fryer to accurately detect the degree of deterioration of the frying oil.

Preferably, the frying oil processing work information reporting system of the present invention

further comprises an advice information presentation unit that, based on the result of the analysis of the deterioration state analysis unit, presents advice information regarding processing relating to the frying oil.

According to this configuration, because the person in charge of cooking at the fried food cooking location is presented with advice information regarding processing relating to the frying oil based on the result of the analysis performed by the deterioration state analysis unit on the frying oil in the fryer, processing relating to the frying oil can be improved even if the person in charge of cooking does not have, inter alia, sufficient knowledge relating to the frying oil.

Preferably, when the frying oil processing work information reporting system of the present invention includes an advice information presentation unit,

the advice information includes information relating to the implementation of oil addition, in which new frying oil is added into the fryer while discarding or not discarding some of the frying oil remaining in the fryer.

According to this configuration, the implementation of oil addition, in which new frying oil is added into the fryer, is presented as advice information to the person in charge of cooking at the fried food cooking location. It is thereby possible to fry high-quality fried food while avoiding unnecessary replacement or addition of the frying oil.

A frying oil processing work information reporting method of the present invention includes

a deterioration state analysis step in which a deterioration state analysis unit analyzes a state of deterioration of frying oil in a fryer filled with frying oil for cooking fried food and installed in a fried food cooking location,

a processing work information recognition step in which a processing work information recognition unit recognizes information about processing work for the frying oil based on the result of the analysis in the deterioration state analysis step, and

a reporting step in which the processing work information is reported.

According to the present invention, the state of deterioration of frying oil in a fryer in a fried food cooking location is analyzed, information about processing work for the frying oil is recognized based on the analysis result, and the recognized processing work information is reported.

As a result, even in cases such as when the person in charge of cooking does not have sufficient knowledge about the frying oil, the work of processing of the frying oil, of which deterioration progresses depending on the circumstances, can be performed properly merely by following the reported processing work information.

Another reporting system of the present invention includes

a deterioration state analysis unit that analyzes a state of deterioration of frying oil in a fryer of a fried food cooking location,

another deterioration state analysis unit that analyzes a state of deterioration of other frying oil in another fryer of another fried food cooking location,

an abnormality determination unit that determines whether or not there is any abnormality in the frying oil in the fryer of the fried food cooking location based on a comparison between the result of the analysis in the deterioration state analysis unit and the result of the analysis in the other deterioration state analysis unit, and

a second reporting unit that reports the fried food cooking location for which the abnormality determination unit determined there to be abnormality in the frying oil in the fryer.

According to the other reporting system of the present invention, it is possible to improve cooking by easily determining, inter alia, situations in which the tendency for the frying oil to deteriorate in the original fried food cooking location is much different from the past tendency for the frying oil to deteriorate, and situations in which said tendency deviates from the tendencies of frying oil to deteriorate in other fried food cooking locations having similar sales and shipment volumes.

Another reporting method of the present invention includes

a deterioration state step in which a state analysis unit analyzes a state of deterioration of frying oil in a fryer of a fried food cooking location,

another deterioration state analysis step in which another deterioration state analysis unit analyzes a state of deterioration of other frying oil in another fryer of another fried food cooking location,

an abnormality determination step in which an abnormality determination unit determines whether or not there is any abnormality in the frying oil in the fryer of the fried food cooking location based on a comparison between the result of the analysis in the deterioration state analysis step and the result of the analysis in the other deterioration state analysis step, and

a second reporting step in which a second reporting unit reports the fried food cooking location when there has been determined to be abnormality in the abnormality determination step.

According to the other reporting method of the present invention, it is possible to improve cooking by easily determining, inter alia, situations in which the tendency for the frying oil to deteriorate in the original fried food cooking location is much different from the past tendency for the frying oil to deteriorate, and situations in which said tendency deviates from the tendencies of frying oil to deteriorate in other fried food cooking locations having similar sales and shipment volumes.

### BRIEF DESCRIPTION OF THE DRAWINGS

FIG. 1 shows a kitchen that cooks fried foods to be sold to customers;

FIG. 2 is a schematic drawing of a network system to which a frying oil processing work information reporting system is applied;

FIG. 3 is a function block diagram of a frying oil processing work reporting apparatus included with shop assistance software installed in an information processing device;

FIG. 4 is a function block diagram of a frying oil processing work reporting apparatus that is different from the frying oil processing work reporting apparatus of FIG. 3;

FIG. 5 is a flowchart of a frying oil processing work reporting method;

FIG. 6 is a flowchart of a scheduling process performed by a processing work information recognition unit;

FIG. 7A is an explanatory drawing of a first planning example when a schedule planning unit plans a processing work schedule on the basis of a business hours schedule for an information processing apparatus and a work hours schedule for a shopworker using the information processing apparatus;

FIG. 7B is an explanatory drawing of a second planning example when the schedule planning unit plans a processing work schedule on the basis of the business hours schedule for the information processing apparatus and a work hours schedule for a shopworker using the information processing apparatus;

FIG. 8A is an explanatory drawing of a first example of processing work schedule planning performed by the schedule planning unit when a plurality of fryers are set up for the information processing apparatus;

FIG. 8B is an explanatory drawing of a second example of processing work schedule planning performed by the schedule planning unit when a plurality of fryers are set up for the information processing apparatus;

FIG. 9 is a flowchart of a frying oil comparison process;

FIG. 10 is an explanatory view of, inter alia, a regression line of a deterioration state created on the basis of analyses results collected from multiple information processing apparatuses;

FIG. 11 is a flowchart of a process of presenting advice information;

FIG. 12 is a graph of the relationship between the time over which the frying oil continues to be heated and the acid value of the frying oil;

FIG. 13 shows the general relationship between the time during business hours of the shop and the temperature of the frying oil in the oil tank of the fryer;

FIG. 14 is a graph of the relationship between deterioration (particularly acid value) and the cumulative time during which the frying oil 17 is at 160° C. or higher; and

FIG. 15 is a graph of how the relationship between the acid value and the usage time of the frying oil in the oil tank changes with respect to an added oil turnover rate R.

### BEST MODE FOR CARRYING OUT THE INVENTION

A preferred embodiment of the present invention is described in detail below. The preferred embodiment relates to a frying oil processing work information reporting system and a frying oil processing work information reporting method in which the present invention is applied to a case where shops that make up a convenience shop chain have an assigned shopworker cook fried food using frying oil of a fryer, and the shops sell the fried food. However, needless to say, the embodiment is not provided by way of limitation on the present invention, which includes the modifications described below, and further includes all the forms included in the scope of the invention as set forth in the claims.

Furthermore, as a supplement, in the following description, like reference symbols are used for substantially the same or equivalent elements and components. In addition, for pairs or groups of elements that have the same composition, reference symbols are used that have the same numbers but different letters of the alphabet as subscripts (e.g., “button switches 23a, 23b, . . . , 23i”). Furthermore, when the elements that make up a pair or set are collectively referred to, the subscripts are omitted and a reference symbol of only the number is used (e.g., “button switches 23”).

(Kitchen)

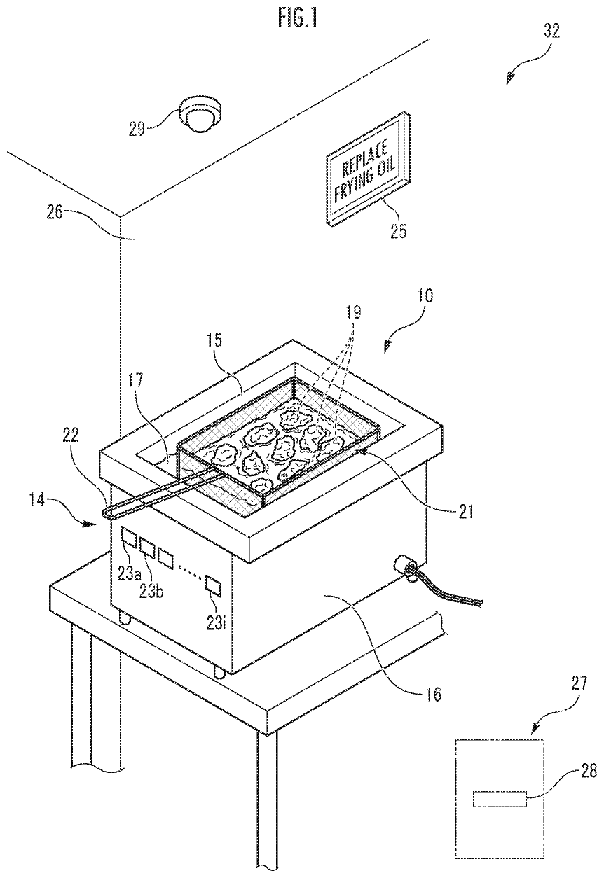

FIG. 1 shows a kitchen 10 where fried foods 19 to be sold to customers are cooked. The kitchen 10 is provided in a shop 32 such as a convenience shop or a supermarket, and an electric fryer 14 is installed in the kitchen.

The fryer 14 has an oil tank 15 and a housing 16 that accommodates the oil tank 15. An upper side of the oil tank 15 is opened, and the oil tank 15 is provided in an upper part of the housing 16. Frying oil 17 is filled in the oil tank 15 until reaching a predetermined height. The fried foods 19 are placed in a frying basket 21 that has a handle 22, and are then immersed in the frying oil 17, which is heated, in the oil tank 15.

The types of fried foods 19 (e.g., (fried) chicken, potatoes, and croquettes) that are placed together in the frying basket 21 and immersed together in the frying oil 17 are usually often the same. Specifically, the immersion time (frying time) in the frying oil 17 is different for each type of fried foods 19, and since the different kinds of fried foods 19 have different immersion times, it is difficult to fry different foods at the same time.

A plurality of button switches 23a, 23b, . . . , 23i are provided in an outer surface of the housing 16 according to the types of fried foods 19, and when a button switch corresponding to a fried food 19 is pressed, and an immersion time suited to the fried food 19 has elapsed, either a buzzer sound is outputted from a speaker (not shown) of the fryer 14 or a display 25 in a wall 26 displays that frying has ended.

A switch for adjusting the temperature of the frying oil 17 may be provided for each type of fried food 19. However, because the temperature of the frying oil 17 often does not change appreciably depending on the type of the fried food 19, it is sufficient if the temperature can be set to a specific temperature.

A camera 29 is hung from the ceiling or attached to the wall 26. The camera 29, which may be either a video camera or a still camera, captures the state in the oil tank 15 of the fryer 14 continuously or at regular time intervals. The type, number, etc., of fried foods 19 in the frying basket 21 can be detected from an output image of the camera 29.

An information processing device 27 is set up inside or outside the shop 32 (the drawing shows an example of the device being set up inside the shop 32), and shop assistance software 28 is installed on the device 27. The information processing device 27 sends data to, and receives data from, the display 25 and the camera 29. The type, number, etc., of fried foods 19 in the frying basket 21 can be detected from captured image data sent from the camera 29 to the information processing device 27. Furthermore, the time over which foods are fried in each frying basket 21 can also be detected because whether or not the frying basked 21 has been loaded into the oil tank 15 can be detected from the image captured by the camera 29.

When frying is performed using the frying oil 17, first, a cook (not shown) in the kitchen 10 puts the fried food 19 into the frying basket 21, and then hangs the frying basket 21 on an upper end of a peripheral wall of the oil tank 15, or submerges the frying basket 21 until the bottom of the frying basket 21 touches the bottom of the oil tank 15, so that all of the fried foods 19 in the frying basket 21 are immersed in the frying oil 17. The cook then presses one button switch 23 corresponding to the type of fried food 19 to be fried in the given instance.

The fryer 14 evaluates which button switch 23 has been operated by the cook, and when the frying time associated with the operated button switch 23 elapses, a buzzer sound is outputted from the speaker (not shown) of the fryer 14 as previously described.

It is also possible to connect the fryer 14 and the information processing device 27 in a wired or wireless scheme such that data can be sent and received, and to report the end of the frying time of the fried food 19 in the fryer 14 to the display 25. Furthermore, as shall be described hereinafter, when the degree of deterioration of the frying oil 17 has been detected and the degree of deterioration has reached a first threshold value, the display 25 may read, for example, “Replace frying oil.”

Furthermore, when the degree of deterioration of the frying oil 17 reaches a second threshold value (that is greater than the first threshold value), the information processing device 27 may, from that point onward, continuously display on the display 25 that the degree of deterioration of the frying oil 17 has reached the second threshold value. Furthermore, the operation of the button switch 23 of the fryer 14 may be disabled so as to forcibly prohibit the use of the fryer 14. The display on the display 25 is fixed in a position that can be visually confirmed by a shopworker other than a person assigned to cooking; e.g., a supervisor.

As a result, an employee becomes aware that frying has ended and pulls up the frying basket 21 to take out the fried food 19 from the oil tank 15. The frying basket 21 can be raised and lowered automatically by providing a drive mechanism.

(Frying Oil Processing Work Information Reporting System)

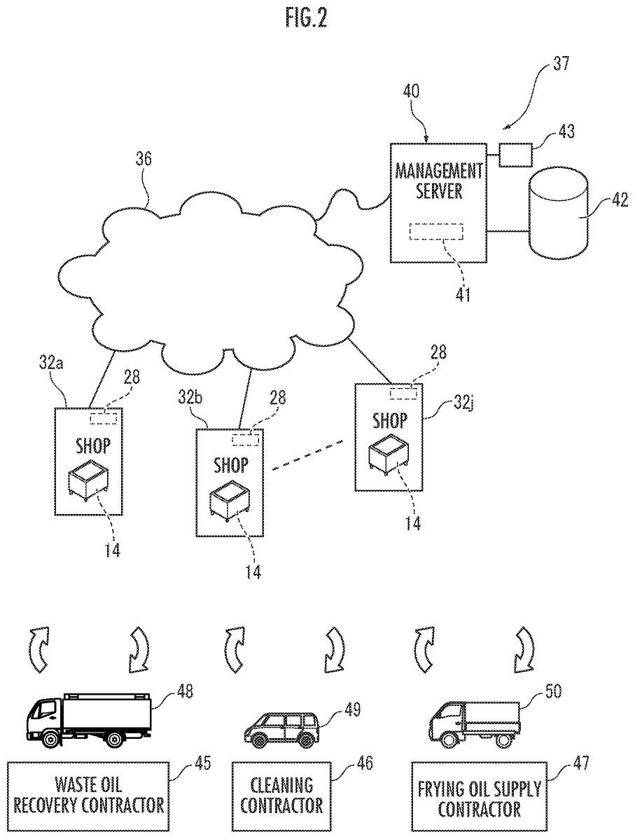

FIG. 2 is a schematic drawing of a network system to which the frying oil processing work information reporting system is applied. Shops 32a, 32b, . . . , 32j make up, for example, a convenience store chain or a supermarket chain, and oversight of the shops is given to headquarters 37 serving as an oversight department.

Each of the shops 32a, 32b, 32j has a fryer 14 and shop assistance software 28 for the information processing devices 27 (FIG. 1).

A management server 40 is set up in the headquarters 37, and this server sends data to, and receives data from, the shop assistance software 28 in the shops 32a, 32b, 32j via the Internet 36. Headquarters software 41 is installed on management server 40, which is connected to a database 42.

In the headquarters 37, the database 42 and a display 43 are connected to the management server 40. The database 42 also serves as a storage device for the management server 40, and information other than that in the database can also be stored as appropriate. The display 43 corresponds to the displays 25 in the shops 32, and can be visually confirmed by the relevant official in the headquarters 37.

The headquarters software 41 executes not only a process of reporting frying oil processing work information, but also sales management (e.g., POS systems), etc. The management server 40 has a well-known structure that includes all basic hardware (e.g., CPU, ROM, RAM, interface, etc.) as resources utilized by a variety of computer software.

In order to assist with a variety of processing work for the frying oil 17 in the shop 32, there are a waste oil recovery contractor 45, a cleaning contractor 46, and a frying oil supply contractor 47 as external contractors common to the multiple shops 32.

The waste oil recovery contractor 45 recovers waste oil from the frying oil 17 of the shop 32. The cleaning contractor 46 cleans the oil tank 15 of the shop 32. The frying oil supply contractor 47 supplies frying oil 17 to the shop 32. The waste oil recovery contractor 45, the cleaning contractor 46, and the frying oil supply contractor 47 drive respective work vehicles 48, 49, 50 and travel in order to one or more shops 32 that are work destinations to perform work at the shops 32.

An employee (e.g., a shopworker) of each shop 32 extracts the deteriorated frying oil 17 from the oil tank 15 of each shop 32 and replenishes a waste oil can with waste oil in the form of the extracted frying oil 17. Typically, the volume of one waste oil can is sufficiently larger than the volume of one new frying oil case filled with new frying oil and is equivalent to a plurality of new frying oil cases.

The work of cleaning the oil tank 15 after the frying oil 17 is extracted may be performed by a specialized cleaning contractor 46 or by an employee (also a shopworker) of each shop 32. The waste oil recovery contractor 45 and the cleaning contractor 46 can be the same contractor. Specifically, the cleaning work entails removing residue adhering to the oil tank 15 and remove dirt on the surface of the oil tank 15 with a neutral detergent or the like.

The employees of each shop 32 replenish the cleaned oil tank 15 with frying oil 17 from an unused frying oil case. The oil tank 15 is not usually cleaned every time the frying oil 17 is replenished, but rather after every several times the frying oil 17 has been replenished.

After the oil tank 15 is cleaned and the oil tank 15 has become dry, replenishment work to replenish the oil tank 15 with frying oil 17 is performed. In a normal shop 32, the frying oil 17 is stored in cases. In a typical shop 32, the cases are sufficiently in stock, and when the inventory reaches about 5 cases, an order is placed with the frying oil supply contractor 47.

(Frying Oil Processing Work Reporting Apparatus: Part 1)

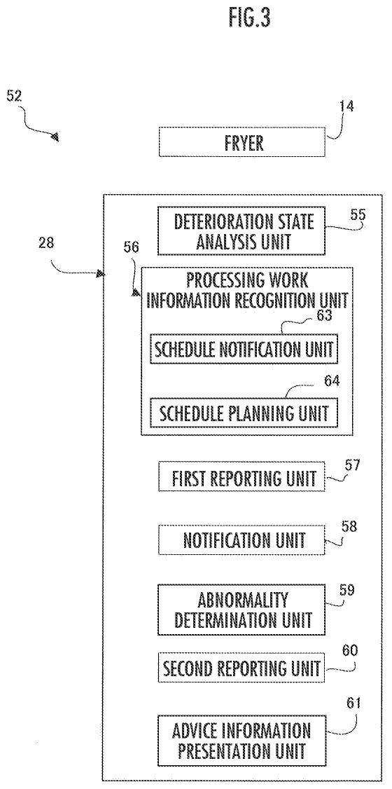

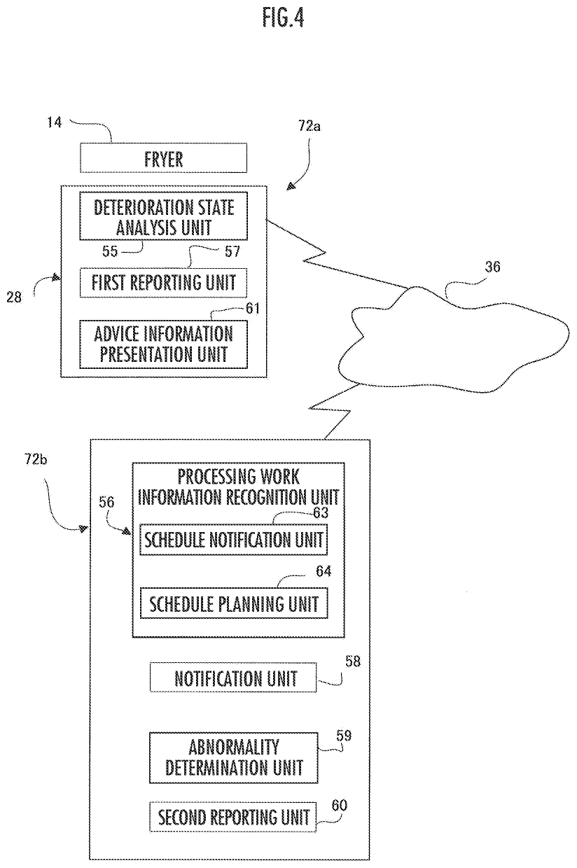

FIG. 3 is a function block diagram of a frying oil processing work reporting apparatus 52 included in the shop assistance software 28 of the information processing device 27. Unlike a frying oil processing work reporting apparatus 72 of FIG. 4 (described hereinafter), this frying oil processing work reporting apparatus 52 is capable of carrying out frying oil processing work reporting unaided.

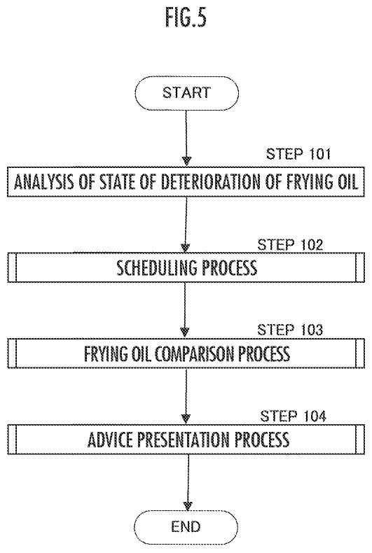

The frying oil processing work reporting apparatus 52 includes the fryer 14, and as other elements, the deterioration state analysis unit 55, the processing work information recognition unit 56, the first reporting unit 57, a notification unit 58, an abnormality determination unit 59, a second reporting unit 60, and an advice information presentation unit 61. The processing work information recognition unit 56 further includes a schedule notification unit 63 and a schedule planning unit 64. The other elements are generated along with the execution of one of several routines included in the shop assistance software 28. The details of the functions shall be described in the flowcharts of FIG. 5 onward (described hereinafter).

The first reporting unit 57 and the second reporting unit 60 can be the same reporting unit rather than being separate. The processing work information recognition unit 56 further includes the schedule notification unit 63 and the schedule planning unit 64. The details of the functions shall be described in the flowcharts of FIG. 5 onward (described hereinafter).

(Frying Oil Processing Work Reporting Apparatus: Part 2)

FIG. 4 is a function block diagram of the frying oil processing work reporting apparatus 72 separate from the frying oil processing work reporting apparatus 52 of FIG. 3. In the frying oil processing work reporting apparatus 52 and the frying oil processing work reporting apparatus 72, blocks that perform the same function have the same reference symbol.

The processes of the frying oil processing work reporting apparatus 72 are distributed to a shop-side processing apparatus 72a and a headquarters-side processing apparatus 72b, which are capable of sending and receiving data via the Internet 36.

The shop-side processing apparatus 72a includes the fryer 14, and as other elements, the deterioration state analysis unit 55, the first reporting unit 57, and the advice information presentation unit 61. The headquarters-side processing apparatus 72b includes, as other elements, the processing work information recognition unit 56, the notification unit 58, the abnormality determination unit 59, and the second reporting unit 60. Other elements are each generated with the execution of a predetermined routine in the shop assistance software 28 or the headquarters software 41 (FIG. 2).

The frying oil processing work reporting apparatuses 52, 72 are both the frying oil processing work information reporting system of the present invention, and are different in whether the function blocks are concentrated in the frying oil processing work reporting apparatus 52 or distributed to the shop-side processing apparatus 72a and the headquarters-side processing apparatus 72b. The description below is of a case in which the frying oil processing work reporting apparatus 72 is employed.

(Frying Oil Processing Work Reporting Method)

FIG. 5 is a flowchart of a frying oil processing work reporting method.

In STEP 101, the deterioration state analysis unit 55 carries out a process of analyzing the state of deterioration of the frying oil 17. Specifically, the deterioration state analysis unit 55 can recognize the degree of deterioration of the frying oil 17 in the oil tank 15 through, for example, one or more of the following methods (a1)-(a8).

(a1) From the output of the camera 29, the deterioration state analysis unit 55 recognizes the date and time when the oil tank 15 of the fryer 14 was replenished with new frying oil 17. The progress of deterioration of the frying oil 17 can then be recognized by counting the types of the fried foods 19 fried in the fryer 14 and the number of times each type was fried.

The type of fried food 19 fried in the fryer 14 and the counting of the number of times each type was fried can also be recognized by counting the number of times the button switches 23 of the fryer 14 were operated.

(a2) The color of the frying oil 17 changes as deterioration progresses. Therefore, the deterioration state analysis unit 55 can monitor the color of the frying oil 17 to recognize the degree of deterioration at the given time.

(a3) The viscosity and rate of increase in viscosity of the frying oil 17 change as deterioration progresses. Therefore, the deterioration state analysis unit 55 can monitor the viscosity (=(measured value of viscosity−measured value before frying fried food)/measured value before frying fried food) of the frying oil 17 to recognize the degree of deterioration at the given time. The degree of deterioration of the frying oil 17 in the oil tank 15 can be recognized by monitoring the oil tank 15 via the camera 29 and, inter alia, measuring the heating time of the frying oil 17, counting the number of times each type of fried food 19 is fried in the oil tank 15, or analyzing the sound generated from the frying oil 17 when the fried food 19 is fried in the frying oil 17.

(a4) An employee of the shop 32 measures the acid value of the frying oil 17 with the color of a test paper such as AV-CHECK® (manufactured by Toyo Filter Paper Co., Ltd.), and inputs the result from a predetermined user interface (e.g., a tablet). The deterioration state analysis unit 55 can recognize the degree of deterioration in the frying oil 17 at the given time on the basis of the measured acid value. When the acid value of the frying oil 17 exceeds 2.5, the frying oil 17 in the oil tank 15 is discarded and replaced with new frying oil 17.

(a5) The odor of the frying oil 17 changes as deterioration progresses. The odor can be measured using an odor sensor such as the Handheld Odor Meter (manufactured by Shinyei Technology Co., Ltd.), and the result is inputted from a predetermined user interface (e.g., a tablet). The deterioration state analysis unit 55 can recognize the degree of deterioration in the frying oil 17 at the given time on the basis of the measured sensor value.

(a6) The amount of polar compound in the frying oil 17 changes as deterioration progresses. The amount of polar compound can be measured using a commercially available polar compound measuring apparatus (manufactured by Testo Co., Ltd., etc.) or the like, and the result is inputted from a predetermined user interface (e.g., a tablet). The deterioration state analysis unit 55 can recognize the degree of deterioration in the frying oil 17 at the given time on the basis of the measured sensor value.

(a7) The state of foaming on the surface of the frying oil 17 changes as the deterioration of the frying oil 17 progresses. For example, the degree of deterioration in the frying oil 17 at the given time can be recognized by performing image analysis, etc., on the condition of the foaming (the state of foam generation) from the output of the camera 29.

(a8) As the deterioration of the frying oil 17 progresses, the sound generated from the frying oil 17 changes when the frying oil 17 in the fryer 14 is frying the fried food 19. For example, the degree of deterioration in the frying oil 17 at the given time can be recognized by performing acoustic analysis, etc., on the sound circumstances from voice output of a microphone built into the camera 29.

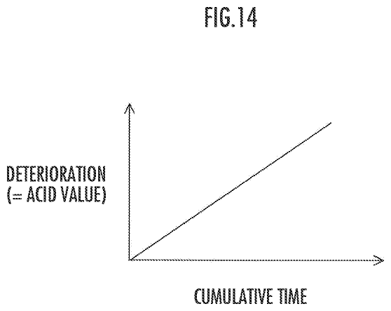

(a9) The frying oil 17 in the fryer 14 progressively deteriorates as a cumulative time, which is equal to or greater than a reference temperature, increases. Therefore, the degree of deterioration in the frying oil 17 at the given time can be recognized by measuring the cumulative time. The relationship between the cumulative time equal to or greater than the reference temperature and the degree of deterioration of the frying oil 17 shall be described later using FIG. 14.

(a10) The degree of deterioration in the frying oil 17 at the given time can be recognized from the temperature at the time of smoke emission. Therefore, the degree of deterioration in the frying oil 17 at the given time can be recognized by recognizing smoke emission from the image captured by the camera 29 and furthermore recognizing the temperature of the frying oil 17 in the fryer 14 at the time of smoke emission from a temperature sensor.

A supplemental description of smoke emission shall be given. The normal oil temperature when frying the fried food 19 is 170-190° C.; no smoke is emitted at this oil temperature. However, as the deterioration of the frying oil 17 progresses, the oil temperature at the time of smoke emission decreases, and smoke emission occurs even at this oil temperature. The smoke emission from the frying oil 17 of the oil tank 15 can be monitored by the camera 29, but a dedicated monitoring camera can be separately set up in the vicinity of the oil tank 15. When the oil temperature at the time of smoke emission is less than 170° C., all or some of the frying oil 17 in the oil tank 15 is discarded. When all of the oil is discarded, the entire amount is replaced with new frying oil 17, and when some of the oil is discarded, the discarded oil is replaced with an equivalent amount of new frying oil 17.

(a11) As the degree of deterioration of the frying oil 17 progresses, polymer adhesion to the inner surface of the fryer 14 and particularly to the height of the surface of the frying oil 17 increases. Therefore, the degree of deterioration in the frying oil 17 at the given time can be recognized by using the camera 29 to monitor the amount of polymer adhering to the inner surface of the fryer 14. As the fryer 14 is cleaned, the amount of the polymer adhered becomes 0. Therefore, the degree of deterioration in the frying oil 17 at the given time can be recognized from the amount of the polymer adhered in the first use period of the frying oil 17 after the cleaning work. However, the cleaning work may be omitted and the frying oil 17 in the fryer 14 may be completely replaced with new frying oil 17. In this case, the amount of the polymer adhering at the start of use of the new frying oil 17 is stored as the initial adhering amount, and the degree of deterioration in the frying oil 17 at the given time is recognized on the basis of the difference between the adhering amount at the given time and the initial adhering amount.

(a12) When the fried food 19 is deep-fried in the frying oil 17 in the fryer 14, a predetermined component is volatilized from the frying oil 17. The volatile component is released to the surroundings and adheres to, for example, a ventilation fan as a decomposition product. Because the amount of volatile component emitted increases as the deep-frying time increases, there is a predetermined relative relationship between the progress of the degree of deterioration of the frying oil 17 and the amount of decomposition product adhered. Based on this, the accumulated amount of decomposition product in the ventilation fan in the kitchen 10 can be monitored from the image taken by the camera 29, and the degree of deterioration in the frying oil 17 at the given time can be recognized on the basis of the increase in the accumulated amount. The decomposition product is removed by cleaning the ventilation fan. Therefore, during the first period of use of the frying oil after removal, the amount of decomposition product adhered indicates the degree of deterioration in the frying oil 17 at the given time. On the other hand, until the decomposition product is removed, the amount of decomposition product adhered at the start of use of the new frying oil 17 is stored as the initial adhesion amount, and the degree of deterioration in the frying oil 17 at the given time is recognized on the basis of the difference between the adhesion amount at the given time and the initial adhesion amount.

(a13) The fryer 14 uses electricity or gas during the cooking of the fried food 19. Therefore, the amount of electric power or gas consumed by the fryer 14 is related to the deep-frying time. In addition, the deterioration of the frying oil 17 progresses as the deep-frying time increases. Thus, the degree of deterioration in the frying oil 17 at the given time can also be recognized on the basis of the amount of electric power or gas consumed by the fryer 14.

Furthermore, the carbonyl value of the frying oil 17 can also be selected as a deterioration indicator of the frying oil 17. When the frying oil 17 oxidizes, a peroxide is first produced. The peroxide then decomposes and produces a carbonyl-group-containing secondary product. Therefore, the degree of deterioration of the frying oil 17 can be analyzed from the carbonyl value of the frying oil 17. When the carbonyl value exceeds 50, all or some of the frying oil 17 in the oil tank 15 is discarded. When all of the oil is discarded, the entire amount is replaced with new frying oil 17, and when some of the oil is discarded, discarded amount is replaced with new frying oil 17.

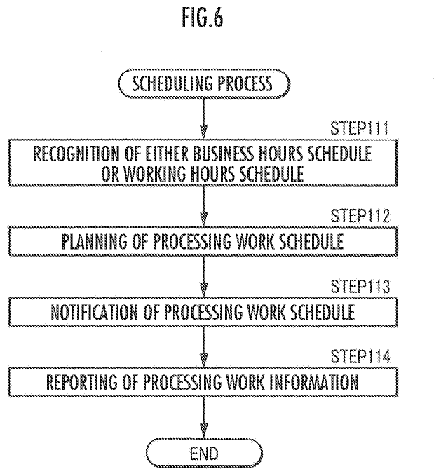

In STEP 102, the processing work information recognition unit 56 recognizes information about processing work for the frying oil 17 on the basis of the analysis result obtained from the deterioration state analysis unit 55 analyzing the state of deterioration of the frying oil 17, and performs a scheduling process. Details of STEP 102 shall be described later using FIG. 6.

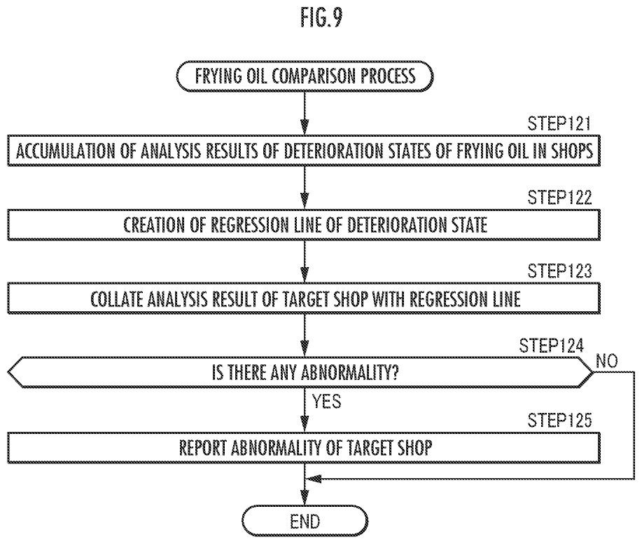

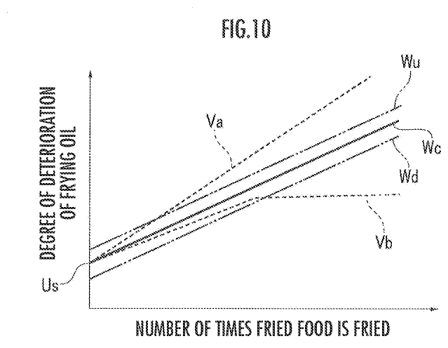

In STEP 103, the processing work information recognition unit 56 compares the frying oil 17 between the shops 32 (including the comparison between the target shop and one or more other shops). Specifically, for example, the progress state of deterioration between the frying oils 17 of the shops 32 is compared. Details of STEP 103 shall be described later using FIG. 9.

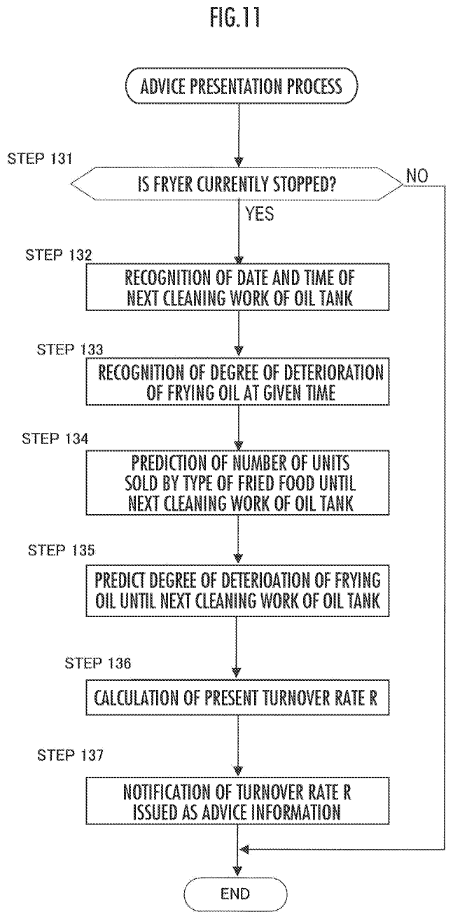

In STEP 104, the advice information presentation unit 61 presents advice information to the employees of the shop 32, particularly to the person in charge of cooking the fried food 19. Specific examples of the advice information shall be described later using FIG. 11.

FIG. 6 is a flowchart of the scheduling process performed by the processing work information recognition unit 56.

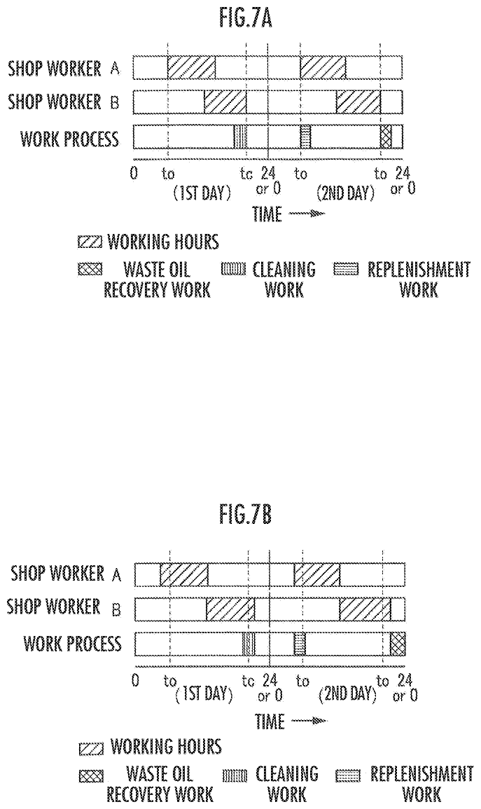

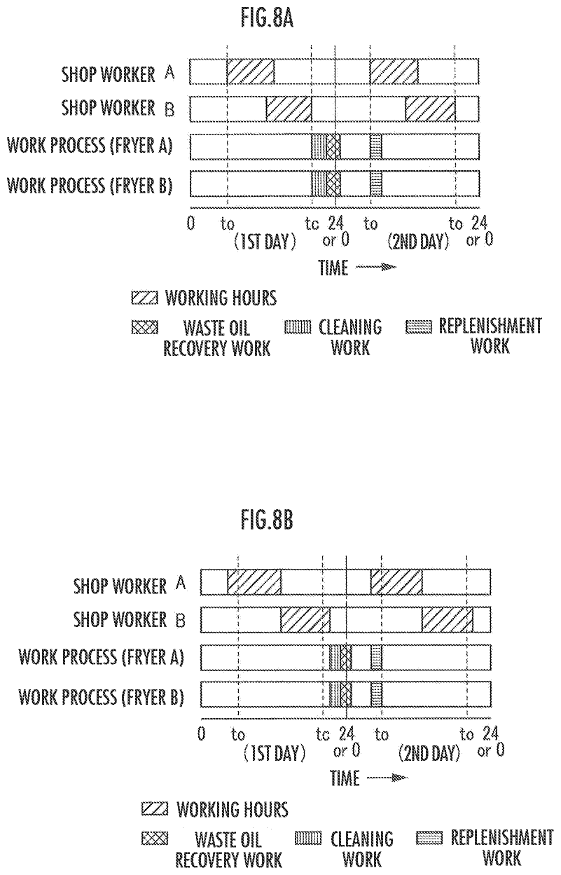

The scheduling process is performed on the basis of the analysis of the state of deterioration of the frying oil 17 in STEP 101, as described in FIG. 5. Therefore, the processing work schedule pertaining to the oil-discarding work, the work of cleaning the oil tank 15, and the work of replenishing the oil tank 15 with frying oil 17 described in the following FIGS. 7A-8B is also designed such that these types of work are performed before the degree of deterioration of the frying oil 17 exceeds the permissible limit, at the point in time it was ascertained that it became necessary, inter alia, to replace the frying oil 17 from the process of analyzing the state of deterioration of the frying oil 17 as performed by the deterioration state analysis unit 55.

The processing work schedule planned on the basis of, inter alia, the business hours schedule of the shop 32 described as an example in FIGS. 7A-8B is planned according to a planning policy that minimizes the effect of the waste oil recovery work, etc., on cooking operation in the shop 32.

Specifically, during the business hours of the shop 32, a planned processing work schedule example is presented so that interruption of cooking of the fried food 19 due to cleaning work, etc., is avoided as much as possible; also so that the waste oil recovery work is performed outside of the operation period and outside of the business hours of the fryer so as not to affect sales operation of the shop 32; and furthermore so that replenishment work, etc., is performed avoiding a busy period when a limited number of shopworkers must serve customers of the shop 32.

In step S111, the schedule notification unit 63 recognizes at least one schedule among a fryer operation schedule, a business hours schedule, and a working time schedule for shopworkers of the shop 32.

In STEP 112, the schedule planning unit 64 plans a processing work schedule to be included in the processing work information reported by the first reporting unit 57 on the basis of the schedule recognized by the schedule recognition unit 63 and the result of the analysis performed by the deterioration state analysis unit 55.

FIGS. 7A and 7B are explanatory views of an example of planning when the schedule planning unit 64 plans a processing work schedule on the basis of the business hours schedule of the shop 32 and the working hours schedule for the shopworkers of the shop 32.

For the sake of simplicity, there are two shopworkers working in the same shop 32: shopworker A and shopworker B.

The letters “to” and “tc” mean the opening time and closing time of the shop 32 where the shopworkers A and B work. FIGS. 7A and 7B depict the schedule planned according to the business hours and working hours of the first day and the second day.

In the examples of FIGS. 7A and 7B, it is assumed that shopworker B will perform the work of cleaning the oil tank 15. On the other hand, in the examples of FIGS. 8A and 8B (described hereinafter), there are a plurality of fryers 14 in a single shop 32, and it is therefore assumed that the work of cleaning the oil tank 15 is performed by an external cleaning contractor 46. Because replenishing the oil tank 15 with new frying oil 17 after cleaning is a relatively simple task, it is assumed that shopworker A who works early in the morning is in charge of replenishing in FIGS. 7A-8B.

Cleaning of the oil tank 15 is not performed every time the frying oil 17 of the oil tank 15 is replenished (replaced), but is usually performed once every several times the oil tank 15 is replenished. In the shop 32, a waste oil can having a sufficiently large volume is prepared for one replenishment frying oil case, and each time old frying oil 17 is removed from the oil tank 15, a shopworker transfers the old frying oil 17 to the waste oil can. In the examples of FIGS. 7A and 7B, before the waste oil can is full, the waste oil recovery contractor 45 comes to the shop 32, and a schedule for collecting the waste oil is planned by the schedule planning unit 64.

In FIG. 7A, shopworker A has a working time schedule in which work starts from the opening time to of the shop 32 on both days (first day and second day). Shopworker B has a working time schedule in which work is ended at the closing time tc of the shop 32 on both days.

In FIG. 7B, shopworker A has a working time schedule in which work starts shortly before the opening time to of the shop 32 on both days (first day and second day). Shopworker B has a working time schedule in which work is ended shortly after the closing time tc of the shop 32 on both days.

In FIGS. 7A and 7B, the schedule planning unit 64 plans a schedule so that the starting timing of the work of replenishing the oil tank 15 with the frying oil 17 is the opening time to of the second day when shopworker A first starts work after cleaning work is completed.

In FIGS. 7A and 7B, the schedule planning unit 64 plans a processing work schedule in which the starting timing of the work of cleaning the frying oil 17 in the oil tank 15 is set so that the completion timing overlaps the work completion time for shopworker B.

The schedule planning unit 64 plans a processing work schedule so that the work time for waste oil recovery performed by the waste oil recovery contractor 45 is within the closing period of the shop 32 so as not to interfere with the business of the shop 32.

In the processing work schedule planning performed by the schedule planning unit 64 in STEP 112, when there are a plurality of fryers 14 in the shop 32, the processing work schedule is planned such that for the plurality of fryers in the same shop, there will or will not be overlap between at least one set of work periods among work periods for the waste oil work, work periods for the cleaning work, and work periods for the replenishment work.

FIGS. 8A and 8B are explanatory drawings of an example of processing work schedule planning performed by the schedule planning unit 64 when a plurality of fryers 14 are set up as fryers A and B in the shop 32. The working times of shopworkers A and B correspond to FIGS. 7A and 7B, respectively.

In the case of FIGS. 8A and 8B, it is assumed that the cleaning of the oil tank 15 is performed by an external cleaning contractor 46 in order to reduce the burden on shopworkers A and B. In addition, in this example, the cleaning contractor 46 also serves as the waste oil recovery contractor 45. Therefore, it is assumed that the cleaning contractor 46 performs the waste oil recovery work as soon as the cleaning of the oil tank 15 is completed.

In FIGS. 8A and 8B, the schedule planning unit 64 plans the processing work schedule such that the cleaning work periods of the fryers A and B overlap each other and the waste oil recovery work periods overlap each other in order to make the cleaning work and waste oil recovery work of the cleaning contractor 46 more efficient.

The progression of the degree of deterioration of the frying oil 17 differs between the fryers A and B. However, the progression of the degrees of deterioration in the fryers A and B can also be controlled so that the timing of the completion of use for the final batch of frying oil 17 (the timing at which the degree of deterioration of the frying oil 17 reaches a predetermined threshold value), before the work of cleaning the fryers A and B, will nearly be the shop closing time tc of the same day. For example, the degrees of deterioration in the fryers are monitored and the types of fried foods 19 fried in the fryers A and B are controlled so that the degrees of deterioration in the fryers progress at nearly the same rate. The rate at which the degree of deterioration of the frying oil 17 progresses is different depending on the type of fried food 19.

The work of replenishing the frying oil 17 after the cleaning work is scheduled as the first work started by shopworker A starts working after the cleaning work.

In STEP 113, the notification unit 58 notifies the people and contractors involved of the processing work schedule planned by the schedule planning unit 64. The people involved include, inter alia, the shopworkers of the shop 32, and the contractors involved include the waste oil recovery contractor 45, the cleaning contractor 46, and the frying oil supply contractor 47.

The notification source of the notification is, for example, the information processing device 27 or the management server 40, and the notification destinations are the waste oil recovery contractor 45, the cleaning contractor 46, and the frying oil supply contractor 47. The form of the notification is generally e-mail. E-mail notifications are sent to destination e-mail addresses.

It is also possible to use an application of an automatic ordering system as a form of notification. In this case, the notification source application automatically notifies the notification destination application of the notification content (processing work schedule).

The notification can also be given in two stages. In such cases, for example, in the first stage, the notification is made to the frying oil supply contractor 47 from the information processing device 27 or the management server 40 by e-mail or an application. In the second stage, the notification is made to the waste oil recovery contractor 45 or the cleaning contractor 46 from the frying oil supply contractor 47 by another e-mail or another application.

The schedule planning unit 64 is able to review and adjust the work schedule between the shops 32 so that the work of each related contractor can be efficiently performed before the planned processing work schedule is sent to the people and contractors involved.

The waste oil recovery contractor 45, the cleaning contractor 46, and the frying oil supply contractor 47 can request a review of the work schedule received from the notification unit 58. In such cases, the schedule planning unit 64 adjusts the work schedule so that the work of the related contractors can be smoothly carried out.

The notification unit 58 re-notifies the people and contractors involved of the adjusted work schedule.

In STEP 114, the second reporting unit 60 reports the schedule planned by the schedule planning unit 64. This report is, for example, visually displayed on both the display 25 of the shop 32 and the display 43 of the headquarters 37.

(Frying Oil Comparison Process)

FIG. 9 is a flowchart of a frying oil comparison process.

In STEP 121, the abnormality determination unit 59 collects from the shops 32 the results of the analyses performed by the deterioration state analysis units 55 of the shops 32.

In STEP 122, the abnormality determination unit 59 creates a regression line of the deterioration state on the basis of the analysis results collected in STEP 111.

FIG. 10 shows a regression deterioration line We of a deterioration state created on the basis of the analysis results collected from multiple shops 32. In FIG. 10, the horizontal axis is the number of fried foods 19. The vertical axis is the degree of deterioration of the frying oil 17. The designation “Us” indicates coordinates corresponding to when the frying oil 17 in the oil tank 15 is replaced with new frying oil 17 and the new oil begins to be used.

As the number of fried foods 19 increases, the degree of deterioration of the frying oil 17 progresses. The increase in the degree of deterioration per piece (unit number) of the number of fried foods 19 differs depending on the type of the fried foods 19. In FIG. 10, the number of fried foods of each type is converted into the number of fried foods of a standard type, and the horizontal axis is the number of fried foods of the standard type.

Thus, the regression deterioration line Wc is completed on the basis of the analyses results collected from multiple information processing apparatuses 33 over a sufficiently long period.

In FIG. 10, Wu and Wd show normal deterioration lines of upper and lower limits with respect to Wc. On the other hand, Va and Vb show deterioration characteristic lines of the analyses results of the frying oil 17 of shops A and B, respectively. Va is an example as a deterioration characteristic line exceeding Wu. Vb is an example of a deterioration characteristic line below Wd. Va and Vb are examples of deterioration characteristic lines assessed to have abnormality in STEP 114 described later.

In STEP 123, the abnormality determination unit 59 collates the deterioration characteristic lines of the shops 32 subject to the abnormality determination with the regression deterioration line.

In STEP 124, the abnormality determination unit 59 determines whether or not there is any abnormality in the analyses results of the shops 32 on the basis of the comparison in STEP 123. When the abnormality determination unit 59 determines that there is abnormality, the process is advanced to STEP 125, and when it is determined that there is no abnormality, the process is ended.

Examples of key items in the presence or absence of abnormality include circumstances where, inter alia, the degree of deterioration of the frying oil 17 reaches the threshold value earlier than with past information for the same shop or information for another shop, circumstances where the time interval of ordering frying oil is shorter due to an earlier time to reach the threshold value for the degree of deterioration.

For example, if a temperature sensor (not shown) attached to the fryer 14 fails and the frying oil 17 in the oil tank 15 becomes hotter than expected, the frying oil 17 deteriorates faster. In addition, the frying oil 17 also deteriorates faster when frying residue has not been adequately removed from the frying oil 17. It is possible to promptly recognize a failure of the temperature sensor in a specific shop 32 and inadequate removal of frying residue and to take appropriate measures, by comparing the time when the deterioration degree threshold of the frying oil 17 is reached and the time interval of ordering the frying oil among multiple shops 32.

In STEP 125, the second reporting unit 60 reports an information processing apparatus 33 determined to have abnormality. This report is made on both the display 25 of the shop 32 determined to have abnormality and the display 43 of the headquarters 37.

An example displayed on the display 43 is, for example, (b1) “Shop 32a has a high rate of deterioration.”

The person in charge of the area who sees the display of (b1) on the display 43 of the headquarters 37 promptly goes to the corresponding shop 32a to investigate.

The abnormality determination unit 59 assesses whether or not there is abnormality on the basis of the comparison between the deterioration characteristic lines of the shops 32 and the regression deterioration line Wc. However, instead of the regression deterioration line Wc, a predetermined shop 32 is set as a model shop for using frying oil 17, and the regression line of the model shop is set as a model regression line. The presence or absence of abnormality is then determined on the basis of a comparison between the model regression line and the deterioration lines of the shops 32, and the second reporting unit 60 may report the determination result on the displays 25 of the shops 32 and on the display 43 of the headquarters 37 via the Internet 36.

(Presentation of Advice Information)

FIG. 11 is a flowchart of a process of presenting advice information. Adding new frying oil 17 to the oil tank 15 (referred to hereinafter as “added oil” as appropriate) shall be described as an example of advice information.

The term “added oil” does not mean that the entire amount of frying oil 17 in the oil tank 15 is replaced with new frying oil 17, but that new frying oil 17 is added to the oil tank 15 in an amount Wn while old frying oil 17 is left in the oil tank 15. When new frying oil 17 is added to the oil tank 15 in the amount Wn, old frying oil 17 is discarded from the oil tank 15 in an amount Wo. Usually, amount Wo=amount Wn and amount W>0, but added oil also includes times when amount Wo<amount Wn or amount Wo=amount Wn.

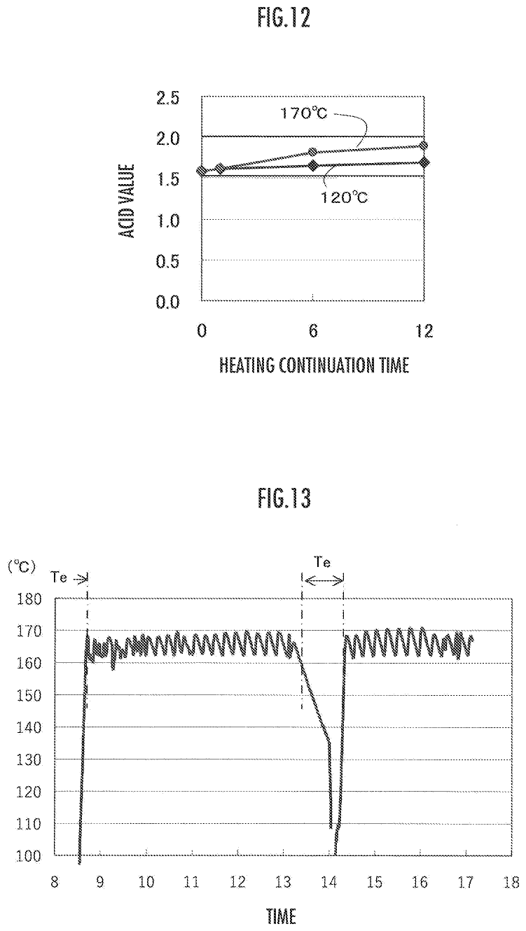

Before FIG. 11 is described, the significance of added oil shall be described with reference to FIGS. 12-15. FIG. 12 is a graph of the relationship between the time over which the frying oil 17 continues to be heated and the acid value of the frying oil 17. This graph shows how the acid value of the frying oil 17 changes in relation to the time of continued heating (0-12 hours) while the frying oil 17 is kept at an equal temperature. It can be seen that when the heating temperature is 120° C., the acid value does not change even if the time of continued heating increases, whereas when the heating temperature is 170° C., the acid value increases as the time of continued heating increases.

The fried food 19 is typically cooked in the fryer 14 with the frying oil 17 in the oil tank 15 kept at 170° C. FIG. 13 shows a typical relationship between the time during business hours of the shop 32 and the temperature of the frying oil 17 in the oil tank 15 of the fryer 14. The fried food 19 is not constantly being cooked in the fryer 14 during the business hours of the shop 32, but intermittently. During the period when the fried food 19 is being cooked in the fryer 14, the temperature of the frying oil 17 in the oil tank 15 is assessed to be 160° C. or higher. Therefore, the period in which the temperature of the frying oil 17 in the oil tank 15 is less than 160° C. is excluded from the cumulative time in FIG. 14 below as an exclusion period Te.

FIG. 14 is a graph of the relationship between deterioration (particularly the acid value) and the cumulative time during which the frying oil 17 is at 160° C. or higher. It can be seen that the acid value and the cumulative time are in a proportional relationship.

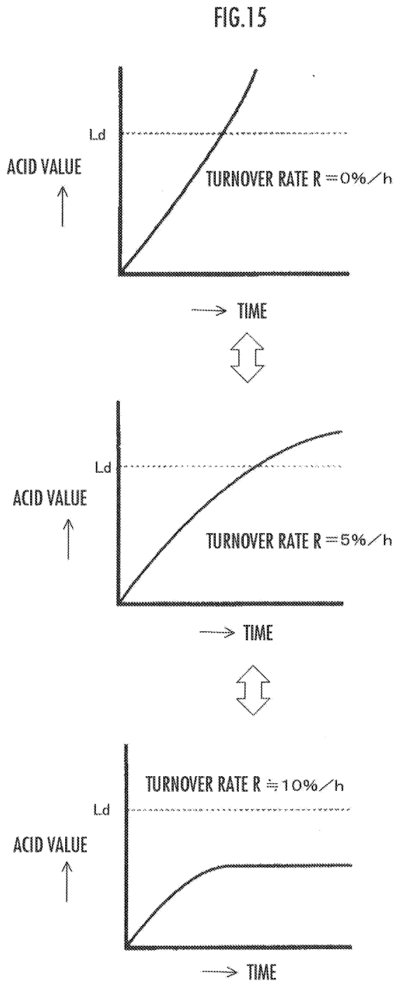

FIG. 15 is a graph of how the relationship between the acid value and the usage time of the frying oil 17 in the oil tank 15 changes with a turnover rate R of the added oil. The turnover rate R is defined by the following equation (1).

R(%/h)={total amount(L) of added oil within set time)/amount of oil filled(L)}÷set time(h)×100% (1)

The amount of oil filled in equation (1) is the volume of the oil tank 15. For example, when the amount of oil filled is 20 L, the set time is 8 hours, and the total amount of added oil within the 8 hours is 10 L, the turnover rate R is calculated from equation (1) as follows.

R(%/h)={10(L)/20(L)÷8(h)×100%=6.25% (2)

The total amount of waste oil is 10 L. The added oil in equation (1) discarded old frying oil 17 in the same amount as the amount added in each addition of new frying oil 17.

If 10% of the amount of oil filled is discarded every day in order to add oil, the amount of waste oil in one month (=30 days) will add up to 300%. In addition, if the total amount (100%) is discarded once every 5 days, the amount of waste oil (*1) in one month will be 600%.

From FIG. 15, as the turnover rate R increases, the acid value of the frying oil 17 in the oil tank 15 be kept commensurately lower. However, the amount of waste oil (amount of frying oil 17 purchased) also commensurately increases as the turnover rate R increases. In addition, when the acid value reaches a waste oil level Ld, it is necessary to replace the entire amount of the frying oil 17 in the oil tank 15 with new frying oil 17. Cleaning of the oil tank 15 is difficult except when the entire amount of frying oil 17 is replaced. When the turnover rate R is approximately 10%, the acid value does not reach the waste oil level Ld and it is therefore not necessary to replace the entire amount of frying oil 17, but it is better to replace the entire amount regularly to clean the oil tank 15.

Therefore, for example, at first oil is added at a turnover rate R of approximately 10%/h, and when it will soon be necessary to clean the frying oil 17 or when the day of performing the work of cleaning the frying oil 17 is approaching, it is efficient to have the turnover rate R be approximately 5 or 0. In addition, it is effective to add oil at a turnover rate R of approximately 10% during a busy season when the fried food 19 sells well, and to have the turnover rate R be approximately 5 or 0 during an off-season. The advice information presentation unit 61 advises the shop 32 on the time period and amount of added oil while referring to the sales of fried food 19 at the shop 32.

In STEP 131 of FIG. 11, the advice information presentation unit 61 determines whether or not the current period is an inactive period of the fryer 14. The inactive period of the fryer 14 is, for example, the exclusion period Te of FIG. 13. The advice information presentation unit 61 advances the process to STEP 132 when the determination is positive, and ends the process when the determination is negative.

In STEP 132, the advice information presentation unit 61 recognizes the work date and time of the next instance of the work of cleaning the oil tank 15 desired by the people involved in cooking the fried food 19 of the shop 32. The people involved in cooking the fried food 19 of the shop 32 can specify in advance the work date and time of the next instance of the work of cleaning the oil tank 15 to the advice information presentation unit 61. The people involved in cooking the fried food 19 of the shop 32 need not give individual instructions to the advice information presentation unit 61 regarding the work date and time of the next work of cleaning the oil tank 15; the advice information presentation unit 61 can also inquire of the processing work information recognition unit 56 and recognize the work date and time therefrom.

In STEP 133, the advice information presentation unit 61 recognizes the degree of deterioration in the frying oil 17 at the given time on the basis of the analysis of the deterioration state analysis unit 55.

In STEP 134, the advice information presentation unit 61 predicts the number of fried foods 19 sold by type until the next work of cleaning the oil tank 15 from the actual sales volume by type of fried food 19 for the past predetermined period (e.g., the past 10 days or 2 weeks).

In STEP 135, the advice information presentation unit 61 predicts the degree of deterioration of the frying oil 17 until the next work of cleaning the oil tank 15 on the basis of the degree of deterioration at the given time and the sales volume of the types of fried food 19 predicted in STEP 134.

In STEP 136, the advice information presentation unit 61 calculates the turnover rate R for the inactive period of the fryer 14 so that the degree of deterioration of the frying oil 17 predicted in STEP 134 does not exceed the threshold value (e.g., the waste oil level Ld of FIG. 15).

In STEP 137, the advice information presentation unit 61 notifies the person in charge of cooking the fried food 19 of the turnover rate R calculated in STEP 134 as advice information. The notification is specifically displayed on the display 25.

(Modification)

The first reporting unit 57 and the second reporting unit 60 of FIGS. 3 and 4 are at least one of a voice reporting unit a visual reporting unit. Possible examples of voice output and visual display that could be used for the reporting performed by voice reporting and visual reporting include (c1) “It will soon be time to replace oil” and (c2) “Oil stock will soon run out.”

In response to the response to the (c1) report, a shopworker can not only manually replace the frying oil 17 in the fryer 14, but also automate the replacement work of the fryer 14 and respond by simply pressing a button. Specifically, when the button is pressed, an opening/closing valve at the bottom of the oil tank 15 opens, and the old frying oil 17 in the oil tank 15 is discharged from the oil tank 15. When the discharging of the old frying oil 17 is completed, the opening/closing valve automatically closes, and a predetermined amount of new frying oil 17 is then automatically supplied to the oil tank 15 via a supply channel.

In response to the (c2) report, a shopworker orders a predetermined amount of frying oil 17. To supply the frying oil 17 to the shop 32, the frying oil supply contractor 47 stops at the shop 32 and supplies frying oil to a frying oil cooking storage tank (not shown). In a small-scale shop 32, the frying oil 17 may be filled in cans having a predetermined volume, and the frying oil 17 may be supplied by the frying oil supply contractor 47 by number of cans.

In FIG. 1, the frying basket 21 is either placed in or removed from the fryer 14 by a worker. However, a raising/lowering mechanism can be added to automatically raise and lower the frying basket 21 in the vertical direction, and when the worker presses a button switch 23, the frying basket 21 set on the raising/lowering mechanism can automatically descend so as to be automatically immersed in the frying oil 17 in the oil tank 15. When the frying time ends, this event will be reported, but additionally, the frying basket 21 can automatically rise so as to separate from the oil tank 15.

(Modification)

The description in the embodiment used a shop 32 as an example of a fried food cooking location. Fried food cooking locations of the present invention include factories as well as shops. This is because fried foods are sometimes fried using frying oil in factories as well.

The description in the embodiment used a shopworker of the shop 32 as an example of a person involved in cooking. Other people involved in cooking of the present invention can include the owner of the shop 32 and employees of a factory.

Possible examples of the headquarters 37 include a shop chain head office, headquarters that manages factories, a frying oil supply contractor (a wholesaler, a frying oil manufacturer, or the like), etc., or a cloud designed by the chain head office or the frying oil supply contractor. In this modification, the headquarters 37 is an oversight department. The oversight department is preferably a shop chain head office, headquarters that manages factories, and a frying oil manufacturer. The oversight department of the present invention does not have to be the headquarters 37, but may be any department that has oversight over the shop 32 regarding the handling of the frying oil 17.

In the embodiment, an electric fryer 14 is used as the fryer. The fryer of the present invention may be any cooking container for frying fried foods in frying oil, and may be a gas or electromagnetic fryer, pan, or the like.

The comparison process of STEP 103 of FIG. 3 was described such that the comparison of the frying oil 17 between the shops 32 by the processing work information recognition unit 56 includes not only a comparison between a target shop and multiple other shops but also a comparison between the target shop and a single other shop. The flowchart of the frying oil comparison process of FIG. 9 is an example of comparison between the target shop and multiple other shops.

On the other hand, in comparison between the target shop and a single other shop, the single other shop determines whether or not there is abnormality in the deteriorated state of the frying oil of the target shop using only the results of analyzing the state of deterioration of the frying oil 17 in two shops 32. The other shop is desirably a shop that has similar characteristics (location, customer attributes, etc.) to the shop in question. This is because it is possible to determine abnormality more appropriately by comparing the analysis results between similar shops 32 than by comparing the analysis results between dissimilar shops 32.

In the embodiment, when the deterioration state analysis unit 55 analyzes the state of deterioration of the frying oil 17 in terms of acid value, viscosity, etc., the viscosity, acid value, and other individual parameters of the frying oil 17 are analyzed using characteristics investigated in testing. However, it is also possible to provide the deterioration state analysis unit 55 with artificial intelligence (AI, machine learning, deep learning) and cause said unit to recognize the state of deterioration of the frying oil 17 at that time.

In the embodiment, the oil tank 15 storing the frying oil 17 is integrally formed in the fryer 14. As a modification, the oil tank storing the frying oil 17 can be separate from the fryer 14, realized in the form of a cartridge. At the start of use, an oil tank cartridge is dropped from above into a recess (for example, a recess such as the oil tank 15 in FIG. 1) formed by opening the fryer 14 upward. Next, a seal wall on the top side of the cartridge is removed, the frying oil 17 inside is exposed upward, and the oil tank cartridge begins to be used as is shown by the oil tank 15 of FIG. 1. When the frying oil 17 has deteriorated and is to be replaced with new frying oil 17, the worker takes hold of an upper peripheral edge of the oil tank cartridge, removes the cartridge from the recess, and replaces the cartridge with a new oil tank cartridge. With such a disposable or recyclable cartridge-type oil tank, complicated work of cleaning the oil tank can be omitted.

In the embodiment, part of the recognition of the deterioration state analysis unit 55 regarding the progress of deterioration of the frying oil 17 is that a sensor can be used instead of manual input from a tablet performed manually by an employee of the shop 32. For example, the color of the test paper in (a4) previously described may be read by an application on a tablet or information processing device 27 from a camera built into the tablet or a camera installed in the vicinity of the fryer 14, and may be recognized by the deterioration state analysis unit 55.

### Effects of Embodiment

The actions and effects of the embodiment are summarized as follows.

1) The system analyzes the state of deterioration of the frying oil 17 of the fryer 14, which is commonly used to cook the fried food 19 of which sales fluctuates widely by type in the shop 32. The information about processing work for the frying oil 17 is then recognized on the basis of the analysis result, and the recognized processing work information is reported on the display 25, etc.

As a result, even in cases such as when the person in charge of cooking does not have sufficient knowledge about the frying oil 17, the work of processing of the frying oil 17, of which deterioration progresses depending on the circumstances, can be performed properly merely by following the reported processing work information.

2) The schedule planning unit 64 plans a processing work schedule on the basis of the operation schedule of the fryer of the shop 32, the business hours schedule, the working time schedule of the person in charge of cooking in the shop 32, and the result of the analysis performed by the deterioration state analysis unit 55 (FIGS. 7A and 7B).

As a result, it is possible to plan a rational processing work schedule accounting for not only the work of processing the frying oil 17 of which deterioration progresses depending on the circumstances, but also the schedule of the shop 32 as a whole. In addition, because the person in charge of cooking can perform not only the work of processing the frying oil 17 but also other work at an appropriate timing, the procedure of the work to be performed by the person in charge of cooking can be rationalized and the business of the shop 32 as a whole can be improved.

3) The schedule planning unit 64 plans the processing work schedule such that at least one set of work periods overlap each other among work periods for the waste oil work, work periods for the cleaning work, and work periods for the replenishment work for a plurality of fryers 14 in the same shop 32 (FIGS. 8A and 8B).

As a result, if the timings of the processing work of the frying oil 17 are intentionally caused to overlap, the processing work can be integrated and the work time can be shortened.

4) The schedule planning unit 64 plans the processing work schedule such that at least one set of work periods do not overlap each other among work periods for the waste oil work, work periods for the cleaning work, and work periods for the replenishment work for a plurality of fryers 14 in the same shop 32 (the modifications of FIGS. 8A and 8B).

Thus, if the processing work is not intentionally caused to overlap, even when there are few people in charge of cooking, it is possible to prevent the processing of one fryer 14 from being stopped while the processing of another fryer 14 is being performed, and to facilitate the processing work.

5) The schedule planning unit 64 plans the processing work schedule of a shop 32 without referring to the result of the analysis performed by the deterioration state analysis unit 55 of another shop 32 (the embodiment of FIG. 3).

As a result, the schedule planning unit 64 of each shop 32 can plan a processing work schedule even without the analysis results of other shops 32. Specifically, because the schedule planning unit 64 of each shop 32 can independently plan a processing work schedule for the shop 32, and can therefore quickly plan a processing work schedule for the shop while not communicating with the schedule planning units 64 of other shops 32 and reducing the processing load.

6) The schedule planning unit 64 plans the processing work schedule of the shop 32 on the basis of the result of the analysis performed by the deterioration state analysis unit 55 of another shop 32 (the embodiment of FIG. 4).

As a result, the schedule planning unit 64 of each shop 32 can refer to the processing work schedule of the other shop 32 to improve the processing work schedule of the original shop 32.

7) The schedule planning unit 64 plans the processing work schedule of the shop 32 on the basis of the schedules of the waste oil recovery contractor 45 performing waste oil recovery work, the cleaning contractor 46 performing cleaning work, and the frying oil supply contractor 47 supplying frying oil 17 to the shop 32 (FIG. 6/the description relating to STEP 113).

It is thereby possible to plan a processing work schedule that is planned by the schedule planning unit 64 and a processing work schedule that matches the schedules of external cooperating contractors such as the waste oil recovery contractor 45. As a result, the schedule planning unit 64 can plan a processing work schedule having improved cooperation with external contractors.

8) The notification unit 58 notifies the waste oil recovery contractor 45, etc., of the processing work schedule in the shop 32 planned by the schedule planning unit 64 (FIG. 6/STEP 113).

It is thereby possible for the waste oil recovery contractor 45 and other cooperating contractors to set a schedule according to the notified processing work schedule and improve their work efficiency as external cooperating contractors.

9) One method of determining abnormality in the usage of the frying oil 17 of the shop 32 is to set a threshold value for the progress of the state of deterioration of the frying oil 17 in the shop 32, and to make a comparison with the threshold value to determine whether or not the frying oil 17 is being used abnormally. On the other hand, in the embodiment, analysis results are collected from the deterioration state analysis units 55 of multiple shops 32, a regression line is created from the collected analysis results, and the analysis results of the shops 32 are collated with the regression line. (FIGS. 9 and 10).

10) The employees of the shop 32 can improve the processing for the frying oil 17 on the basis of the advice information presented by the advice information presentation unit 61 regarding the processing for the frying oil 17 based on the result of the analysis performed by the deterioration state analysis unit 55 on the frying oil 17 in the fryer 14.

11) The implementation of oil addition, in which new frying oil 17 is added into the fryer 14, is presented as advice information to the employees of the shop 32. It is thereby possible to fry high-quality fried food 19 while avoiding unnecessary replacement or addition of the frying oil 17.

In the embodiment, the state of deterioration of the frying oil 17 in the fryer 14 is analyzed on the basis of various detection parameters. When the color of the frying oil 17 is used as a detection parameter, subtle color changes can be detected easily and inexpensively from images captured by a color camera. When viscosity, viscosity increase rate, or acid value is used as a detection parameter, the variation in the correspondence between these parameters and the state of deterioration of the frying oil 17 is small, and the detection precision can therefore be increased.

Because odor diffuses readily into the surroundings, when odor is used as a detection parameter, the state of deterioration of the frying oil 17 can be detected even from a location sufficiently distant from the fryer 14. When the cumulative time at or above the reference temperature of the frying oil 17 is used as a detection parameter, the variation in the detected value is small, and the state of deterioration of the frying oil 17 can therefore be detected inexpensively and precisely with little space using a temperature sensor and a timer. When the sound generated by the frying oil 17 during deep frying is used as a detection parameter, an inexpensive microphone or the like can be used as a sensor.

When the temperature at the time of smoke emission from the frying oil 17 is used as a detection parameter, the relationship between the temperature at the time of smoke emission and the temperature of the frying oil 17 is highly reliable, and it is therefore possible to detect the state of deterioration of the frying oil 17 with high reliability. Because the state of foam generation in the frying oil 17 can be easily detected from an image captured by a camera, oversight can be reduced. The amount of polymer on the inner surface of the fryer 14 and the accumulated amount of decomposition product due to volatilization of the frying oil 17 can be detected even while the fryer 14 is stopped, and it is therefore possible to reduce restrictions on detection time. When the amount of electric power or gas consumed by the fryer 14 is used as a detection parameter, a power meter or a gas meter can be attached to the fryer 14 to accurately detect the degree of deterioration of the frying oil 17.

The regression line of the embodiment shows the average usage of the frying oil 17 in multiple shops 32, and the shops 32 can therefore easily and accurately determine the circumstances of the usage of the frying oil 17 in the original shop in relation to the average of multiple shops or the past information for the original shop by collating the result of the analysis performed by the deterioration state analysis unit 55 in the original shop with the regression line.

The frying oil supply contractor 47 of the embodiment is, in common sense, a frying oil delivery contractor that specializes in delivering the frying oil 17 to the shops 32. However, if a contractor delivers the frying oil 17 to the shops 32, the frying oil supply contractor 47 need not be a frying oil delivery contractor that specializes in delivery. A wholesaler of the frying oil 17 or a frying oil manufacturing/distributing contractor may be the frying oil supply contractor 47.

In a typical division of roles between contractors, orders for the frying oil 17 from the shops 32 are placed with a wholesaler, a frying oil manufacturing/distributing contractor is contacted by the wholesaler and delivers and supplies the frying oil 17 to the shops 32. The frying oil manufacturing/distributing contractor can receive an order directly from a shop 32 without dealing with the shop 32 via a wholesaler, and can deliver and supply the frying oil 17 to the shop 32 that has received the order. Furthermore, the frying oil manufacturing/distributing contractor can, in response to an order for the frying oil 17 received from the wholesaler or the shop 32, manufacture the frying oil 17 on the basis of the order.

### KEY TO SYMBOLS

14: Fryer
15: Oil tank
17: Frying oil
19: Fried food
32: Shop
37: Headquarters (oversight department)
45: Waste oil recovery contractor
46: Cleaning contractor
47: Frying oil supply contractor
52, 72: Frying oil processing work reporting apparatus (frying oil processing work information reporting system)
55: Deterioration state analysis unit
56: Processing work information recognition unit
57: First reporting unit
58: Notification unit
59: Abnormality determination unit
60: Second reporting unit
61: Advice information presentation unit
63: Schedule notification unit
64: Schedule planning unit

1. A system for reporting A frying oil processing work information, the system comprising a processor and a memory having program code stored therein for execution by the processor,
wherein the processor executes the computer program code to:
analyze a state of deterioration of frying oil, for frying fried food, in a fryer installed in a fried food cooking location;
recognize information about processing work for the frying oil based on the deterioration state of the frying oil; and
report the recognized information about processing work.

2. The system according to claim 1,
wherein the processor executes the computer program code to: further,
recognize the processing work information including at least one schedule of an operation schedule of the fryer, a business hours schedule of the fried food cooking location, and a working hours schedule for a person in charge of cooking in the fried food cooking location; and
based on the recognized schedule and the analyzed state of deterioration, plan a processing work schedule to be included in the reported processing work information.

3. The system according to claim 2, wherein the processing work schedule includes a start timing for at least one type of work among waste oil work for the frying oil, cleaning work for the fryer, and work of replenishing the fryer with the frying oil.

4. The system according to claim 3, wherein the processor executes the computer program code to: further, plan the processing work schedule such that at least one set of work periods overlap or do not overlap each other among work periods for the waste oil work, work periods for the cleaning work, and work periods for the replenishment work for a plurality of fryers in the same fried food cooking location.

5. The system according to claim 2, wherein the processor executes the computer program code to: further, plan the processing work schedule of the fried food location independently of the analyzed deterioration state of another fried food location.

6. The system according to claim 2, wherein the processor executes the computer program code to: further, plan the processing work schedule of the fried food location based on the analyzed deterioration state of another fried food location.

7. The system according to claim 2, wherein the processor executes the computer program code to: further, plan the processing work schedule of the fried food cooking location based on at least one contractor among a waste oil recovery contractor performing waste oil work, a cleaning work contractor performing cleaning work, and a supply contractor supplying the frying oil to the fried food cooking location.

8. The system according to claim 2, wherein the processor executes the computer program code to: further, issue notification of the processing work schedule of the fried food cooking location to at least one contractor among a waste oil recovery contractor performing waste oil work, a cleaning work contractor performing cleaning work, and a supply contractor supplying the frying oil to the fried food cooking location.

9. The system according to claim 1,
wherein the processor executes the computer program code to: further,
determine whether or not there is any abnormality in the frying oil in the fryer of the fried food cooking location based on a comparison between the analyzed deterioration state and a deterioration of frying oil in another fried food cooking location; and
report the determined abnormality.

10. The system according to claim 1, wherein the processor executes the computer program code to: further, analyze the state of deterioration of the frying oil based on at least one of the following: color of the frying oil in the fryer, viscosity, viscosity increase rate, acid value, odor, cumulative time at or above reference temperature, sound generated by the frying oil during deep-frying, oil temperature when the frying oil emits smoke, state of foam generation, amount of polymer on the inner surface of the fryer, accumulated amount of decomposition product due to volatilization of the frying oil, and amount of electric power or gas consumed by the fryer.

11. The system according to claim 1, wherein the processor executes the computer program code to: further, based on the analyzed deterioration state, present advice information regarding processing relating to the frying oil.

12. The system according to claim 11, wherein the advice information includes information relating to the implementation of oil addition, in which new frying oil is added into the fryer while discarding or not discarding some of the frying oil remaining in the fryer.

13. A method, of reporting a frying oil processing work information, for executing a machine instruction in a central processing unit, the method comprising steps of:
analyzing a state of deterioration of frying oil in a fryer filled with frying oil for cooking fried food and installed in a fried food cooking location;
recognizing information about processing work for the frying oil based on the analyzed deterioration state; and
reporting the recognized processing work information.

14. A system for reporting frying oil processing work information, the system comprising a processor and a memory having program code stored therein for execution by the processor,
wherein the processor executes the computer program code to:
analyze a state of deterioration of frying oil in a fryer of a fried food cooking location;
analyze a state of deterioration of other frying oil in another fryer of another fried food cooking location;
determine whether or not there is any abnormality in the frying oil in the fryer of the fried food cooking location based on a comparison between the analyzed deterioration state and the analyzed other deterioration state analysis unit; and
report the determined abnormality to the fried food cooking location.

15. A method, of reporting a frying oil processing work information, for executing a machine instruction in a central processing unit, the method comprising steps of:
analyzing a state of deterioration of frying oil in a fryer of a fried food cooking location,
analyzing a state of deterioration of other frying oil in another fryer of another fried food cooking location;
determining whether or not there is any abnormality in the frying oil in the fryer of the fried food cooking location based on a comparison between the analyzed deterioration state of the frying oil and the analyzed deterioration state of the other frying oil; and
reporting the determined abnormality to the fried food cooking location.
